(19) United States
(12) Patent Application Publication
(10) Pub. No.: US 2021/0154902 A1
(43) Pub. Date: May 27, 2021

(54) MIXING EXTRUDER FOR AN INJECTION MOLDING MACHINE

(71) Applicant: Hsiu-Feng WEN, Taichung City (TW)

(72) Inventor: Hsiu-Feng WEN, Taichung City (TW)

(21) Appl. No.: 16/820,951

(22) Filed: Mar. 17, 2020

(30) Foreign Application Priority Data
Nov. 21, 2019 (TW) 108215424

(51) Int. Cl. B29C 45/58; B29C 45/60; B29C 45/62; B29C 45/63

(52) U.S. Cl. CPC B29C 45/581; B29C 45/63; B29C 45/62; B29C 45/60

(57) ABSTRACT

A mixing extruder for an injection molding machine includes a barrel unit and an extruder screw. The barrel unit includes an extruder tube. The extruder screw includes a screw rod, a helical mixing channel, and a helical gas flow channel communicating with the helical mixing channel. The helical mixing channel and helical gas flow channel both extend around the screw rod. The helical mixing channel extrudes a paste outwardly from a material discharge opening formed at an end of the extruder tube, whereas the helical gas flow channel connects a suction pump through a gas discharge channel formed in the extruder tube oppositely of the material discharge opening.

### CROSS-REFERENCE TO RELATED APPLICATION

This application claims priority of Taiwanese Utility Model Patent Application No. 108215424, filed on Nov. 21, 2019.

### FIELD

The disclosure relates to a mixing extruder, more particularly to a mixing extruder for an injection molding machine.

### BACKGROUND

Referring to FIG. 1, a conventional injection molding machine includes a feed hopper 11, a mixing device 12 disposed downstream of the feed hopper 11, and a forming device 13 disposed downstream of the mixing device 12. The mixing device 12 includes a heating tube unit 121 disposed downstream of the feed hopper 11, and an extruder screw 122 extending rotatably through the heating tube unit 121.

To operate the conventional injection molding machine, plastic pellets 114 are poured into the feed hopper 11, enters the heating tube unit 121 through the feed hopper 11, and is melted into a paste (not shown). Then, the extruder screw 122 is rotated to drive the paste to be extruded into the forming device 13 for further processing.

However, as the paste of plastic pellets 114 is blended, gaseous substances released from polymers and air entering through the feed hopper 11 can be blended into the paste. Thus, gas bubbles are formed in the finished product and adversely affect the quality of the finished product.

### SUMMARY

Therefore, the object of the disclosure is to provide a mixing extruder that can alleviate the drawback of the prior art.

According to the disclosure, a mixing extruder for an injection molding machine includes a barrel unit and an extruder screw.

The barrel unit includes an extruder tube, a material discharge opening formed at an end of the extruder tube, a feed inlet communicating with an inside of the extruder tube, and a gas discharge channel disposed at one side of the feed inlet opposite to the material discharge opening. The extruder tube has an extruding portion and a gas suction portion connected to the extruding portion. The gas discharge channel is formed in the gas suction portion.

The extruder screw is rotatably disposed inside the extruder tube, and includes a screw rod, a helical mixing channel, and a helical gas flow channel. The screw rod is divided into a mixing section situated inside the extruding portion, a gas flow section connected to the mixing section and situated inside the gas suction portion, and a trigger connecting section connected to the gas flow section oppositely of the mixing section. The helical mixing channel is disposed helically on the mixing section, and the helical gas flow channel is disposed helically on the gas flow section and communicates with the helical mixing channel and the gas discharge channel of the barrel unit.

The helical mixing channel is configured to extrude a paste material outwardly from the material discharge opening, and the gas discharge channel of the barrel unit is configured to fluidly connect a suction pump so that gases can be pumped out from the extruder tube through the helical gas flow channel and the gas discharge channel.

### BRIEF DESCRIPTION OF THE DRAWINGS

Other features and advantages of the disclosure will become apparent in the following detailed description of the embodiment with reference to the accompanying drawings, of which:

FIG. 1 is a schematic view of a conventional injection molding machine;

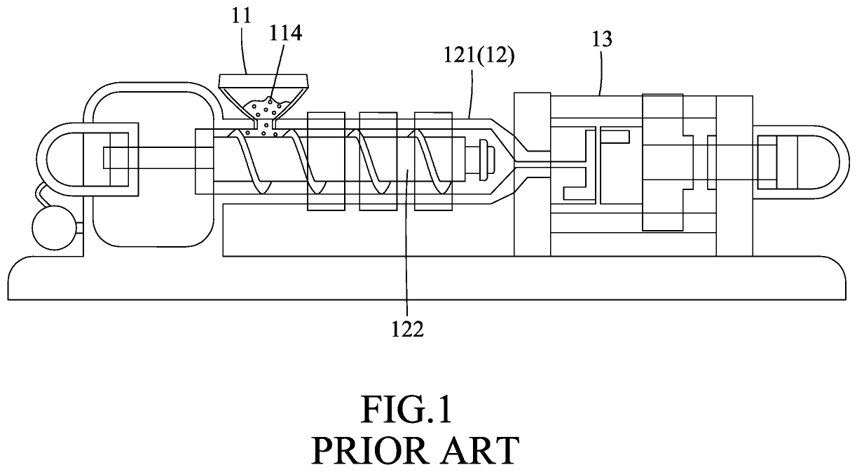

FIG. 2 is a fragmentary partly sectional view of an embodiment of a mixing extruder according to the disclosure;

FIG. 3 is partial magnified view of FIG. 2; and

FIG. 4 is similar to FIG. 2, illustrating gases from a material inside an extruder tube of the embodiment being pumped out through a helical gas flow channel and a gas discharge channel of the embodiment.

### DETAILED DESCRIPTION

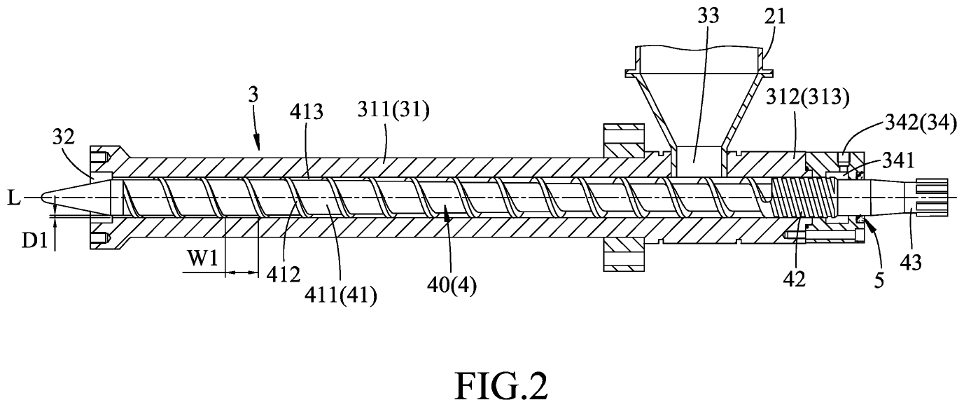

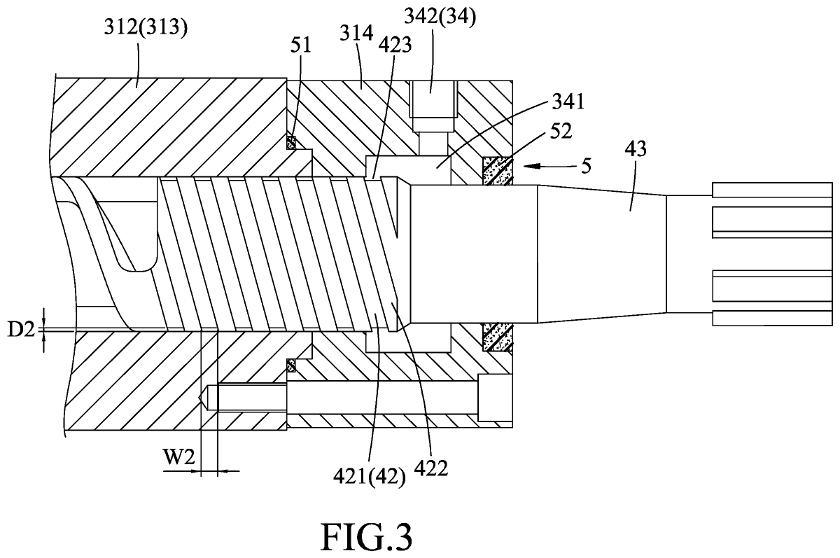

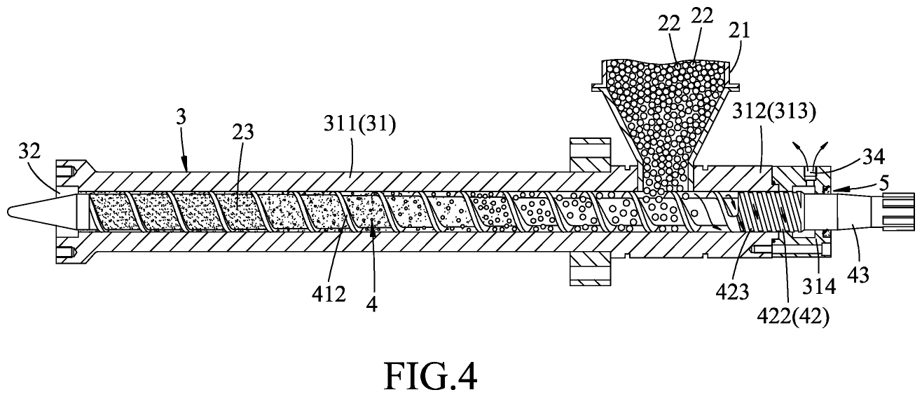

Referring to FIGS. 2, 3, and 4, an embodiment of a mixing extruder for an injection molding machine is configured to connect to a hopper device 21 and a vacuum pump (not shown), to be filled with plastic pellets 22, and to extrude a paste material 23. The mixing extruder includes a barrel unit 3, an extruder screw 4, and a sealing unit 5. An extension direction of the extruder screw 4 is defined as an axial line (L).

The barrel unit 3 includes an extruder tube 31 surrounding the axial line (L), a material discharge opening 32 formed at an end of the extruder tube 31, a feed inlet 33 communicating with an inside of the extruder tube 31 and configured to be connected to the hopper device 21, and a gas discharge channel 34 communicating with the inside of the extruder tube 31 and disposed at one side of the feed inlet 33 opposite to the material discharge opening 32.

The extruder tube 31 has an extruding portion 311 and a gas suction portion 312 connected to the extruding portion 311. The gas suction portion 312 has a connection part 313 connected to the extruding portion 311 of the extruder tube 31, and an extension part 314 detachably and airtightly connected to the connection part 313 and opposite to the extruding portion 311. The gas discharge channel 34 is formed in the extension part 314.

The gas discharge channel 34 has a gas collection region 341 indented from an inner periphery surface of the extension part 314 and extending around said helical gas flow channel 423, and a gas outlet hole 342 communicating with the gas collection region 341, opening at an outer periphery of the extension part 314, and configured to fluidly connect a suction pump so that gases can be pumped out from the extruder tube 31 through the helical gas flow channel 423 and the gas discharge channel 34. The gas collection region 341 has a width that is measured along the axial line (L) of the extruder screw 4 and that is greater than that of the gas outlet hole 342.

The extruder screw 4 is rotatably disposed inside the extruder tube 31, and includes a screw rod 40, a helical mixing channel 413, and a helical gas glow channel 423. The screw rod 40 is divided into a mixing section 41, a gas flow section 42 connected to the mixing section 41, and a trigger connecting section 43 connected to the gas flow section 42 oppositely of the mixing section 41. The mixing section 41 is situated inside the extruding portion 311, and the gas flow section 42 is situated inside the gas suction portion 312. The helical mixing channel 413 is disposed helically on the mixing section 41 and communicates with the material discharge opening 32, and the helical gas flow channel 423 is disposed helically on the gas flow section 42 and communicates with the helical mixing channel 413 and the gas discharge channel 34 of the barrel unit 3.

The mixing section 41 includes a base stem part 411 extending along the axial line (L), and a helical ridge 412 connected helically to the base stem part 411. The helical mixing channel 413 is defined by the base stem part 411 and the helical ridge 412. The helical mixing channel 413 is configured to extrude the material 23 outwardly from the material discharge opening 32.

A depth of the helical mixing channel 413 decreases from one end of the helical mixing channel 413 adjacent to the helical gas flow channel 423 to the other end of the helical mixing channel 413 adjacent to the material discharge opening 32.

The gas flow section 42 has a base stem part 421 extending along the axial line (L) and a helical ridge 422 connected helically to the base stem part 421. The helical gas flow channel 423 is defined by the base stem part 421 and the helical ridge 422. In this embodiment, the helical mixing channel 413 and the helical gas flow channel 423 extend in a same helical direction.

The helical mixing channel 413 has a minimum depth (D1) greater than a depth (D2) of the helical gas flow channel 423.

The helical mixing channel 413 has a width (W1) measured along the axial line (L) that is greater than a width (W2) of the helical gas flow channel 423 measured along the axial line (L). The width (W2) of the helical gas flow channel 423 is smaller than the width of the gas collection region 341 measured along the axial line (L).

The sealing unit 5 includes a first sealing member 51 disposed between the connection part 313 and the extension part 314, and a second sealing member 52 disposed between the trigger connecting portion 43 and the extension part 314 such that the trigger connecting portion 43 has a gas-tight and rotatable relationship with the gas suction portion 312 of the extruder tube 31. In this embodiment, the first sealing member 51 is an O-shaped seal ring that surrounds the axial line (L), and the second sealing member 52 is also an O-shaped seal ring that surrounds the trigger connecting portion 43.

To use the mixing extruder for an injection molding machine, first the plastic pellets 22 is filled into the extruder tube 31 through the hopper device 21 and the feed inlet 33. Then, a portion of the extruding portion proximal to the material discharge opening 32 is heated, and the extruder screw 4 is rotated about the axial line (L) to drive the plastic pellets 22 so that the plastic pellets 22 are moved along the helical mixing channel 413 toward the material discharge opening 32 and are melted into the paste material 23.

During operation, the upstream side of the hopper device 21 is sealed in an airtight manner, and the vacuum pump is operated to pump out gas through the gas discharge channel 34. Because the upstream of the hopper device 21 is sealed airtightly and the paste material 23 proximal to the material discharge opening 32 is heated and melted, a substantially airtight space is formed within the extruder tube 31. Hence, the vacuum pump may pump out gases mixed with the paste material 23 through the helical gas flow channel 423 and the gas discharge channel 34 as the extruder screw 4 rotates, thereby reducing gas bubbles in the paste material 23.

As the extruder screw 4 continues to rotate, the paste material 23 is extruded through the material discharge opening 32 for further processing.

In this embodiment, because the helical mixing channel 413 and the helical gas flow channel 423 extend in the same helical direction, during rotation of the extruder screw 4, the plastic pellets 22 and the paste material 23 can all be driven to move in one direction, i.e., toward the material discharge opening 32 and not away from the material discharge opening 32 and into the helical gas flow channel 423. In other embodiments, the helical mixing channel 413 and the helical gas flow channel 423 may extend in different helical directions, as long as the width (W2) and depth (D2) of the helical gas flow channel 423 is smaller than the dimensions of the plastic pellets 22 to prevent the plastic pellets 22 from entering the helical gas flow channel 423.

In this embodiment, the gas collection region 341 of the gas discharge channel 34 extends around the helical gas flow channel 423 so that the helical gas flow channel 423 maintains a constant fluid connection therewith during rotation of the extruder screw 4. Moreover, the width (W2) of the helical gas flow channel is smaller than the width of the gas collection region 341 measured along the axial line (L) to reduce pressure of the gas in the gas collection region 341 to make it easier to pump out said gas from the gas collection region 341.

In sum, when the extruder screw 4 rotates, the helical channel 413 extrudes the paste material 23 from the material discharge opening 32, while gases mixed with the paste material 23 may be pumped out through the helical gas flow channel 423 and the gas discharge channel 34 to reduce the gas bubbles in the paste material 23.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A mixing extruder for an injection molding machine, comprising:
a barrel unit including an extruder tube, a material discharge opening that is formed at an end of said extruder tube, a feed inlet that communicates with an inside of said extruder tube, and a gas discharge channel that is disposed at one side of said feed inlet opposite to said material discharge opening, said extruder tube having an extruding portion and a gas suction portion that is connected to said extruding portion, said gas discharge channel being formed in said gas suction portion; and
an extruder screw rotatably disposed inside said extruder tube, and including
a screw rod that is divided into a mixing section situated inside said extruding portion, a gas flow section connected to said mixing section and situated inside said gas suction portion, and a trigger connecting section connected to said gas flow section oppositely of said mixing section,
a helical mixing channel that is disposed helically on said mixing section, and
a helical gas flow channel that is disposed helically on said gas flow section and that communicates with said helical mixing channel and said gas discharge channel of said barrel unit;
wherein said helical mixing channel is configured to extrude a paste material outwardly from said material discharge opening, and said gas discharge channel of said barrel unit is configured to fluidly connect a suction pump so that gases can be pumped out from said extruder tube through said helical gas flow channel and said gas discharge channel.

2. The mixing extruder as claimed in claim 1, wherein said helical mixing channel and said helical gas flow channel extend in a same helical direction.

3. The mixing extruder as claimed in claim 2, wherein said helical mixing channel has a minimum depth greater than a depth of said helical gas flow channel.

4. The mixing extruder as claimed in claim 3, wherein the depth of said helical mixing channel decreases from one end of said helical mixing channel adjacent to said gas flow channel to the other end of said helical mixing channel adjacent to said material discharge opening.

5. The mixing extruder as claimed in claim 2, wherein said helical mixing channel has a width that is greater than that of said helical gas flow channel.

6. The mixing extruder as claimed in claim 1, wherein said gas suction portion of said extruder tube has a connection part connected to said extruding portion of said extruder tube, and an extension part detachably and airtightly connected to said connection part and opposite to said extruding portion, said gas discharge channel being formed in said extension part.

7. The mixing extruder as claimed in claim 6, wherein said gas discharge channel has a gas collection region indented from an inner periphery surface of said extension part and extending around said helical gas flow channel, and a gas outlet hole communicating with said gas collection region and opening at an outer periphery of said extension part, said gas collection region having a width that is measured along an axial line of said extruder screw and that is greater than that of said gas outlet hole.

8. The mixing extruder as claimed in claim 7, wherein said helical gas flow channel has a width along the axial line, which is smaller than said width of said gas collection region.

9. The mixing extruder as claimed in claim 6, further comprising a sealing unit that includes a first sealing member disposed between said connection part and said extension part.

10. The mixing extruder as claimed in claim 9, wherein said trigger connecting portion of said extruder screw has an exposed part exposed from said extension part, said sealing unit further including a second sealing member that is disposed between said trigger connecting portion and said extension part such that said trigger connecting portion has a gas-tight and rotatable relationship with said gas suction portion of said extruder tube.
